(19) United States
(12) Patent Application Publication
(10) Pub. No.: US 2005/0074645 A1
(43) Pub. Date: Apr. 7, 2005

(54) Apparatus and method for solid oxide fuel cell and thermionic emission based power generation system

(76) Inventors: Gerald Thomas Fattic, Fishers, IN (US); Kaushik Rajashekara, Carmel, IN (US); Harry L. Husted, Kokomo, IN (US)

Correspondence Address: DELPHI TECHNOLOGIES, INC., M/C 480-410-202, PO BOX 5052, TROY, MI, 48007, US

(21) Appl. No.: 10/676,549

(22) Filed: Oct. 1, 2003

(51) Int. Cl. H01M 8/04; H01M 8/12; H01M 16/00

(52) U.S. Cl. 429/26; 429/30; 429/9

(57) ABSTRACT

A method and apparatus for providing a source of power, comprising: a solid oxide fuel cell system and a thermionic device. The solid oxide fuel cell system provides a first source of power, wherein the solid oxide fuel cell system produces heat waste when the solid oxide fuel cell is providing the first source of power. The thermionic device for provides a second source of power, the thermionic device provides the second source of power from the heat waste which is provided to said thermionic device and an exhaust conduit provides fluid communication between an exhaust of the fuel cell system and a heat exchanger of the thermionic device.

### CROSS REFERENCE TO RELATED APPLICATIONS

This application is related to commonly owned and assigned U.S. patent application Ser. No. ______, entitled: APPARATUS AND METHOD FOR SOLID OXIDE FUEL CELL AND THERMO PHOTOVOLTAIC CONVERTER BASED POWER GENERATION SYSTEM, attorney docket no. DP-310113, filed contemporaneously with this application, the contents of which are incorporated herein by reference thereto.

### TECHNICAL FIELD

This application relates to a method and apparatus for providing a solid oxide fuel cell and thermionic based power generation system. More particularly a solid oxide fuel cell and thermionic based power generation system wherein the solid oxide fuel cell provides a heat source to the thermionic power generation system.

### BACKGROUND

Alternative fuels for vehicles and other stationary power supplies have been represented as enablers to reduce toxic emissions in comparison to those generated by conventional fuels. At the same time, tighter emission standards and significant innovation in catalyst formulations and engine controls has led to dramatic improvements in the low emission performance and robustness of gasoline and diesel engine systems. This has certainly reduced the environmental differential between optimized conventional and alternative fuel vehicle systems. However, many technical challenges remain to make the conventionally-fueled internal combustion engine a nearly zero emission system having the efficiency necessary to make the vehicle commercially viable.

One approach to addressing the issue of emissions is the employment of fuel cells, particularly solid oxide fuel cells (“SOFC”), in a vehicle. A fuel cell is an energy conversion device that generates electricity and heat by electrochemically combining a gaseous fuel, such as hydrogen, carbon monoxide, or a hydrocarbon, and an oxidant, such as air or oxygen, across an ion-conducting electrolyte. The fuel cell converts chemical energy into electrical energy. SOFCs are constructed entirely of solid-state materials, utilizing an ion conductive oxide ceramic as the electrolyte. A conventional electrochemical cell in a SOFC is comprised of an anode, a cathode with a ceramic electrolyte.

In a typical SOFC, a fuel flows to the anode where it is oxidized by oxygen ions from the electrolyte, producing electrons that are released to the external circuit, and mostly water and carbon dioxide are removed in the fuel flow stream. At the cathode, the oxidant accepts electrons from the external circuit to form oxygen ions. The oxygen ions migrate across the electrolyte to the anode. The flow of electrons through the external circuit provides for consumable or storable electricity.

It is also noted that single-sided SOFC's have recently been demonstrated where the anode and cathode are interleaved on the same side of the electrolyte and fuel/air is flowed over them. In these SOFCs the oxidant passes over the oxygen electrode (cathode) while the fuel passes over the fuel electrode (anode), generating electricity, water, and heat.

Solid oxide fuel cells are used for generation of electrical power using hydrogen and carbon monoxide as fuels. The hydrogen is obtained from fuels including but not limited to: natural gas, gasoline, jet fuel, diesel fuel, and fuel obtained using coal gasification. The solid oxide fuel cell operates at extremely high temperatures of the order of 700-1000 degrees Celsius thus, the waste heat generated is of high temperature or high grade waste heat.

However, the SOFC usually requires a start up time of approximately 20-30 minutes and depending on the application and/or the type of SOFC the start up time may be on the order of multiple hours, which depending on the particular application of the power supply may require the use of an additional power supply or energy storage device to provide the required power during the start up time of the SOFC.

Accordingly, it is desirable to provide a power system employing a fuel cell wherein the waste heat generated by the fuel cell is ultilized by another power generating system. In addition, it is also desirable to provide an alternative means for providing power during the fuel cell's start up time.

### SUMMARY

The drawbacks and deficiencies discussed above are overcome or alleviated by a method and apparatus for providing a source of power, comprising: a solid oxide fuel cell system and a thermionic device. The solid oxide fuel cell system provides a first source of power, wherein the solid oxide fuel cell system produces heat waste when the solid oxide fuel cell is providing the first source of power. The thermionic device provides a second source of power from the waste heat which is provided to said thermionic device in thermal communication with the solid oxide fuel cell.

A method for generating power is also provided wherein the method comprises: generating power from a thermionic device, the thermionic device generating power from heat received from a start up combustor under a first operating condition; and generating power from a solid oxide fuel system, the solid oxide fuel system generating a heat exhaust when the solid oxide fuel system generates power, the heat exhaust being routed to the thermionic device, wherein the thermionic device generates power from heat exhaust when the heat exhaust reaches a predetermined temperature for energy conversion by the thermionic device.

In another exemplary embodiment a power supply is provided, the alternative power supply comprising: a solid oxide fuel cell system for providing a first source of power, the solid oxide fuel cell system producing heat waste when the solid oxide fuel cell is providing the first source of power; a start up combustor for providing another source of heat; and an exhaust conduit providing fluid communication between an exhaust of the fuel cell system and an exhaust of the start up combustor to a first heat exchanger of a thermionic device, the thermionic device for providing a second source of power from heat received from either the start up combustor or the fuel cell system.

The above-described and other features and advantages of the present invention will be appreciated and understood by those skilled in the art from the following detailed description, drawings, and appended claims.

### BRIEF DESCRIPTION OF THE DRAWINGS

FIG. 1 is a schematic illustration of a fuel cell and thermionic emission based power system in accordance with an exemplary embodiment of the present invention,

FIG. 2 is a schematic illustration of an another exemplary embodiment of a fuel cell and thermionic emission based power system;

FIGS. 3-5 are schematic illustrations of other exemplary embodiments of fuel cell and thermionic emission based power systems;

FIG. 6 is a schematic illustration of the operation of a thermionic device; and

FIG. 7 is a graph illustrating the combined efficiency of a fuel cell and thermionic emission based power system presuming a 65% utilization of the waste heat of the fuel cell and a 20% conversion efficiency of the thermionic device.

### DETAILED DESCRIPTION OF EXEMPLARY EMBODIMENTS

Disclosed herein is an apparatus and system that combines two power systems wherein the waste by product of one system is used to generate power in the other system.

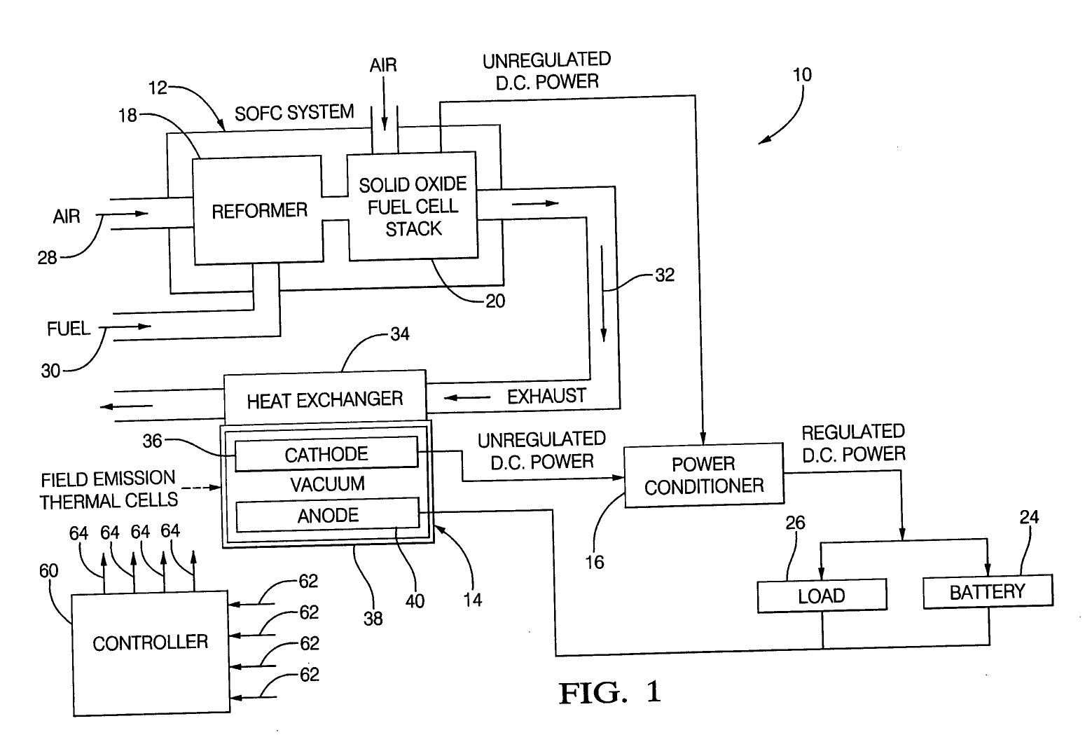

Referring now to FIG. 1 a fuel cell and thermionic emission based power system 10 is illustrated. Fuel cell and thermionic emission system 10 comprises a fuel cell 12 and a thermionic field emission device 14 each being configured to provide DC power to a power conditioner 16, which converts the unregulated DC power of the fuel cell and the thermionic field emission device to regulated DC power.

In an exemplary embodiment, fuel cell 12 comprises a reformer 18 and a solid oxide fuel stack 20. It is also possible that SOFC could be operated without a reformer, using directly hydrogen fuel.

Different types of SOFC systems exist, including tubular or planar systems. These various systems can operate with different cell configurations therefore, reference to a particular cell configuration and components for use within a particular cell configuration are intended to be provided as examples and the present invention is not intended to be limited by the same.

Generally, the system may comprise at least one SOFC, at least one thermionic device, one or more heat exchangers, and a power conditioner for providing power to either or both an electric storage medium 24 or a multiplicity of electrical loads 26. If the loads and the power sources are compatible, the power conditioner may not be required. Thus, the power conditioner is optional.

During operation the SOFC can be operated at high adiabatic temperatures, e.g. up to about 1,000° C., with typical operating temperatures of bout 600° C. to about 900° C., and preferably about 650° C. to about 800° C. Typically at least one heat exchanger is employed to cool the SOFC effluent. However, and in accordance with exemplary embodiments of the present invention the heat exchanger is configured to provide a source of heat to a thermionic device.

To facilitate the production of electricity by the SOFC, a direct supply of simple fuel, e.g., hydrogen, carbon monoxide, and/or methane is preferred. However, concentrated supplies of these fuels are generally expensive and difficult to supply. Therefore, the fuel utilized can be obtained by processing a more complex fuel source. The actual fuel utilized in the system is typically chosen based upon the application, expense, availability, and environmental issues relating to the fuel. Possible fuels include hydrocarbon fuels, including, but not limited to, liquid fuels, such as gasoline, diesel, ethanol, methanol, kerosene, and others; gaseous fuels, such as natural gas, propane, butane, and others; and “alternative” fuels, such as hydrogen, biofuels, dimethyl ether, and others; synthetic fuels, such as synthetic fuels produced from methane, methanol, coal gasification or natural gas conversion to liquids, and combinations comprising at least one of the foregoing methods, and the like; as well as combinations comprising at least one of the foregoing fuels.

Furthermore, the fuel for the SOFC can be processed in reformer 18. A reformer generally converts one type of fuel to a fuel usable by the SOFC (e.g., hydrogen or carbon monoxide).

Other examples of SOFC and potential applications are found in U.S. Pat. Nos. 6,230,494 and 6,321,145, the contents of which are incorporated herein by reference thereto.

The SOFC may in one embodiment be used in conjunction with an engine, for example, to produce power to a vehicle. Within the engine, air, and/or fuel are burned to produce energy, while the remainder of unburned fuel and combustion byproducts, (e.g., carbon monoxide) is used as fuel in the SOFC.

As discussed, herein the term “engine” is meant in the broad sense to include all combustors which combust hydrocarbon fuels, such as internal combustion engines, diesel engines, stirling engines, etc.

As illustrated in FIG. 1, the heated exhaust of the fuel cell is provided to the thermionic device 14 via a conduit which provides fluid communication between fuel cell 12 and thermionic field device 14.

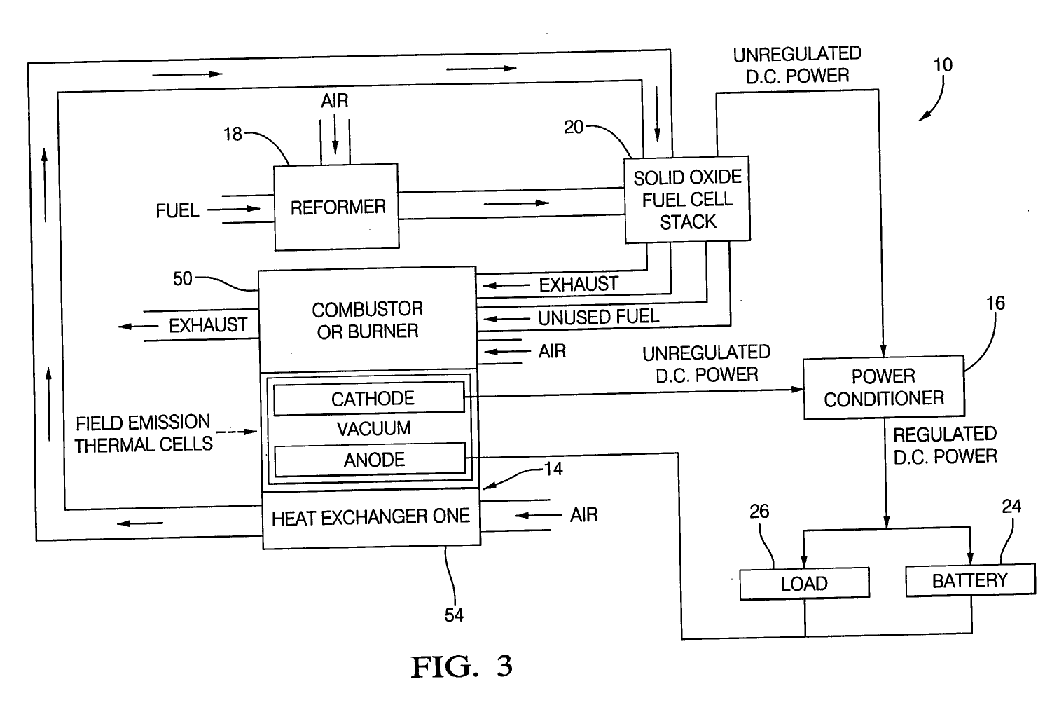

Alternatively, and as illustrated in FIGS. 3-5, alternative methods of thermal communication such as physical contact between the thermionic device and the stack, waste energy burner, or reformer are illustrated.

In accordance with an exemplary embodiment the thermionic field device is a device which can convert the heat energy or exhaust of the SOFC into electric energy by thermionic emission without any additional heating of the exhaust of the SOFC.

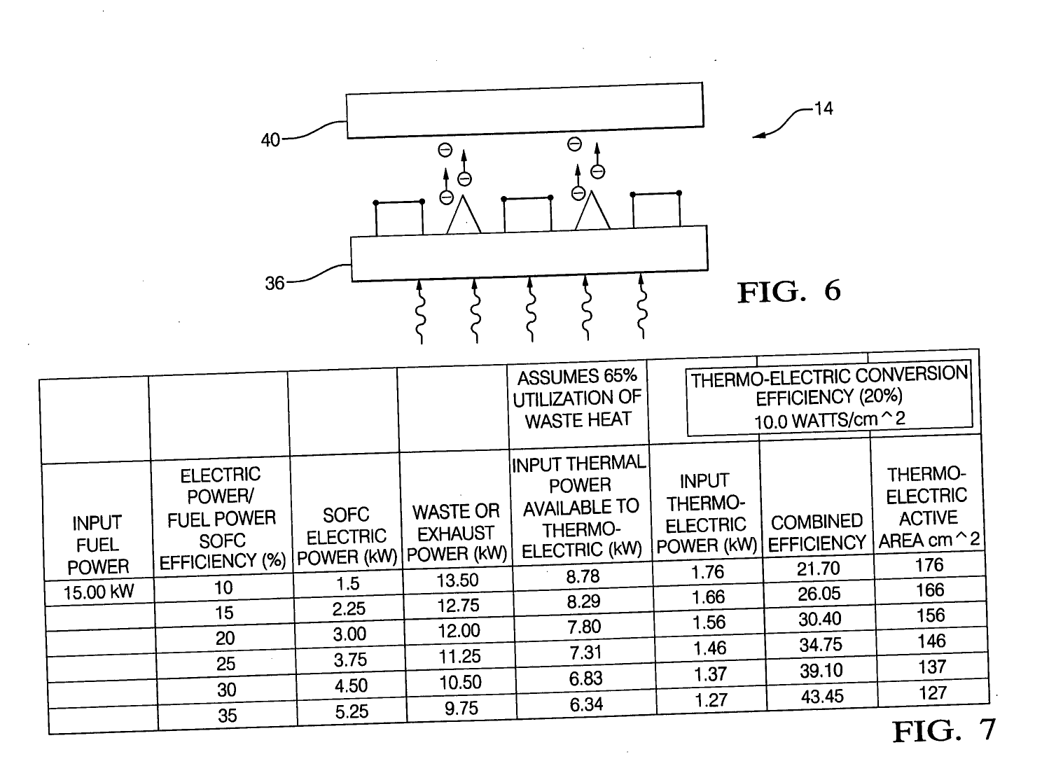

As is known in the related arts thermionic energy conversion involves a process wherein electrons are thermionically emitted from a surface by introducing heat sufficient to cause some electrons of the surface to overcome retarding forces at the surface in order to escape. See also FIG. 6 wherein the energy conversion of a thermionic device is illustrated schematically.

A thermionic energy converter comprises at least one electrode or cathode connected to a heat source or heat exchanger, a second electrode or anode connected to a heat sink and separated from the first electrode by an intervening space and leads connecting the electrodes to the electric load, and an enclosure. The space in the enclosure is either highly evacuated or filled with a suitable rarefied vapor, such as cesium. Alternatively, the thermionic device has a semiconductor material at the anode and cathode with a physical junction between the anode and cathode instead of a vacuum.

When a heat source supplies heat at a high enough temperature to one electrode, electrons are thermionically evaporated into the evacuated or rarefied-vapor-filled interelectrode space or alternatively a semiconductor material. The electrons move toward the other electrode, the collector, which is kept at a low temperature near that of the heat source or heat sink. There the electrons condense and return to the hot electrode via external electric leads and an electric load or battery connected between the emitter and the collector. Recent technological advances have developed thermionic devices that can produce electrical output with heat input on the order of 700 degrees Celsius, which in accordance with an exemplary embodiment is attainable by the exhaust of the SOFC. Thus, it is contemplated that an exemplary embodiment of the present invention will employ a thermionic device which is capable of providing power from the waste heat of the SOFC.

In accordance with an exemplary embodiment, system 10 is contemplated for use with a thermionic device which can produce power when the heat exhaust of the fuel cell is provided to the cathode or emitter of the device. An exemplary temperature of the heated exhaust of the fuel cell is up to 1,000° C. with an optimum operating temperature of about 700° C.

An example one such a device is found in U.S. Pat. Nos. 6,396,191 and 6,489,704 the contents of which are incorporated herein by reference thereto. Of course, any thermionic device capable of providing an electrical output from the operating temperature of the fuel cell stack is contemplated to be used with exemplary embodiments of the present invention.

Accordingly, and as illustrated in FIG. 1, the thermionic device is configured for use with a heat exchanger 34. The heat exchanger is configured and positioned to receive heated exhaust from fuel cell stack 12.

Heat exchanger 34 provides heat energy to a cathode or emitter 36. Emitter or cathode 36 is received within a housing 38 and is in a facing spaced relationship with regard to an anode or collector 40 which receives the electrons as they pass through a vacuum disposed between emitter 36 and collector 40. Collector 40 is also received within housing 38. A circuit is provided between the emitter and collector for providing a source of power to power conditioner 22. In an exemplary embodiment power conditioner regulates the DC power provided by the fuel cell and the thermionic device. In addition, and as an alternative, power conditioner is a DC/AC inverter, or alternatively no conditioner is required.

In order to provide additional efficiency, the heat exhaust from the heat exchanger can be recirculated back into fuel cell system 12.

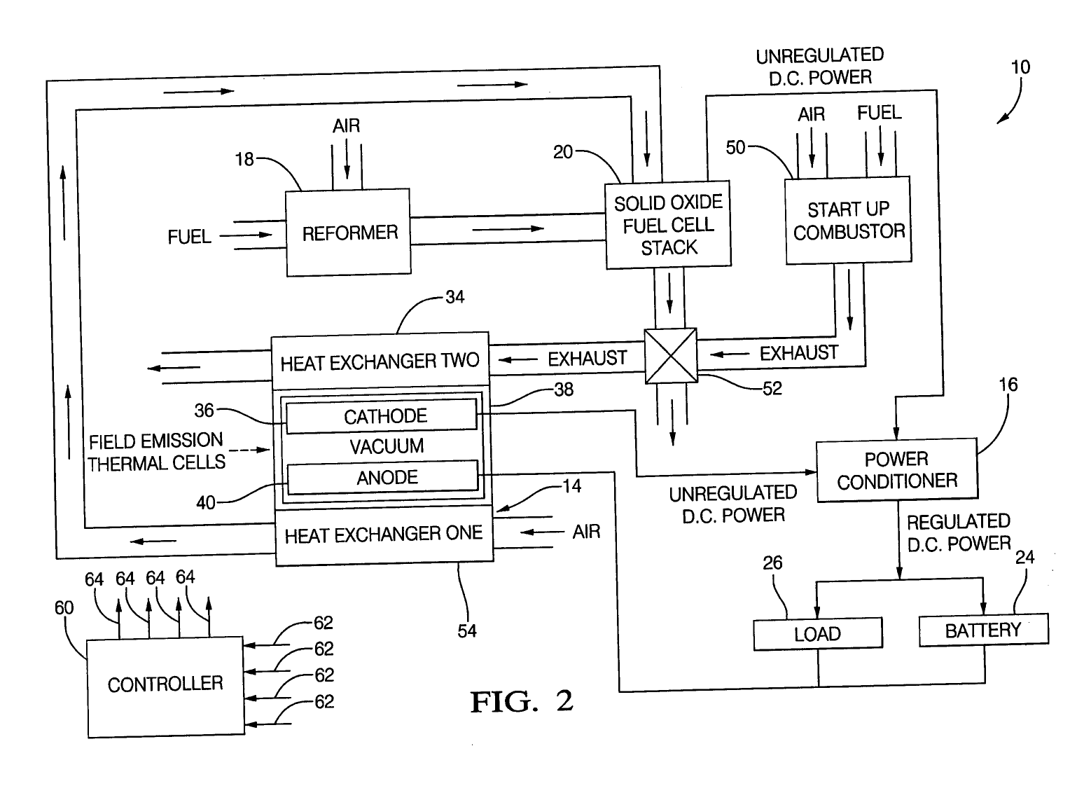

Referring now to FIG. 2 an alternative embodiment is illustrated. Here a start up combustor 50 is employed in the system. Start up combustor is provided with fuel and air to provide heat to heat exchanger 34 of thermionic device 14 in order to induce a power output in accordance with the methodologies discussed above. Start up combustor may be any combustion device capable of providing at least a heat output. For example, and in an alternative embodiment start up combustor may be an engine of a vehicle such as a hybrid vehicle. Start up combustor 50 is configured to provide heat to the thermionic device until fuel cell stack 20 has reached an operating temperature wherein the exhaust of the fuel cell stack is sufficient to provide the required heat to the thermionic device at which time the start up combustor will be shut down. In this embodiment, the start up combustor will, through the use of thermionic device 14 provide electrical power in applications where the 20-30 minute warm up period of the fuel cell stack is undesirable. Thus, thermionic device 14 provides power immediately upon request through the use of start up combustor 50. The use of a start up combustor will eliminate the need for an electric storage medium which is typically used to provide a source of power in systems employing fuel cell systems, which can take up to several minutes to start-up (e.g., produce power and heat). During the startup time period, the electrical power is used for running the air supply blower, a controller, control actuators, and other electricity-consuming devices in the fuel cell system.

In addition to start up combustor 50, a diverter valve 52 is provided to control the flow of heated exhaust or effluent from combustor 50 and fuel cell stack 12. Also, another heat exchanger 54 is configured and positioned to provide cooling air to the anode of the thermionic device. The output of this heat exchanger is in fluid communication with the fuel cell stack.

Alternatively, heat exchanger 54 is a special purpose heat exchanger configured to provide an air stream just for cooling the heatsink, or it could, for example, be engine induction air. In yet another alternative exemplary embodiment, instead of air, a cooling liquid could be used on its own loop, or shared with an engine coolant loop.

In yet another alternative exemplary embodiment the heated air from exchanger 54, after cooling the anode, is provided to fuel cell stack 10 in order to assist in bringing the stack up to an operating temperature during startup and to assist in preheating air to the stack during normal operation. It is also noted that any of the heat exchangers and/or systems coupled to the anode of the thermionic device, as discussed herein and illustrated in the attached figures, maybe use in any of the disclosed systems (e.g., FIG. 1).

Referring now to FIG. 3 another exemplary configuration of power system 10 is illustrated. Here combustor or burner 50 is directly coupled to the cathode of the thermionic device in order to provide the necessary heat to free the electrons from the cathode. This burner may have coatings to provide catalytic action, such as platinum, rhodium, or palladium. In addition, combustor or burner 50 is provided with the unused fuel of the solid oxide fuel stack as well as a separate air or unheated air input for use in the combustion process. Also, heat exchanger 54 is provided with an air intake in order to keep the anode at a desired temperature with respect to the cathode of the thermionic device.

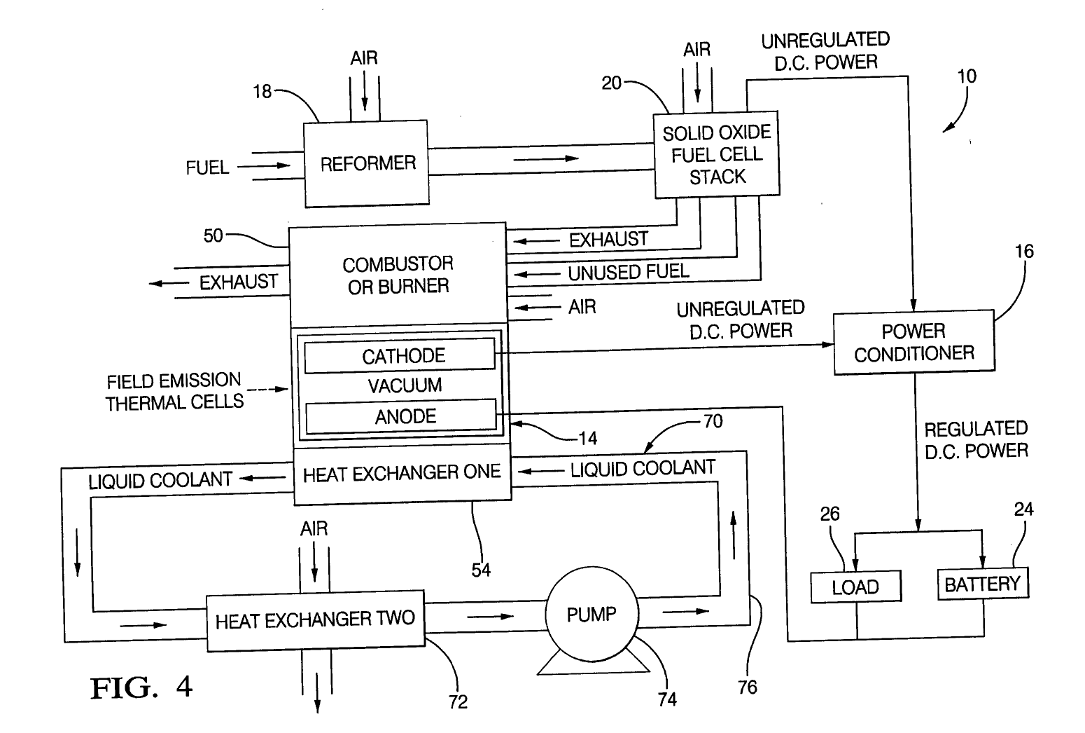

Referring now to FIG. 4 yet another alternative embodiment is illustrated here heat exchanger 54 is provided with a cooling system 70. Cooling system 70 comprises another heat exchanger 72, a pump 74 each being in fluid communication with a circuit or conduit for providing the coolant to heat exchanger 54 in order to assist in cooling or the maintaining of the temperature of the anode of the thermionic device.

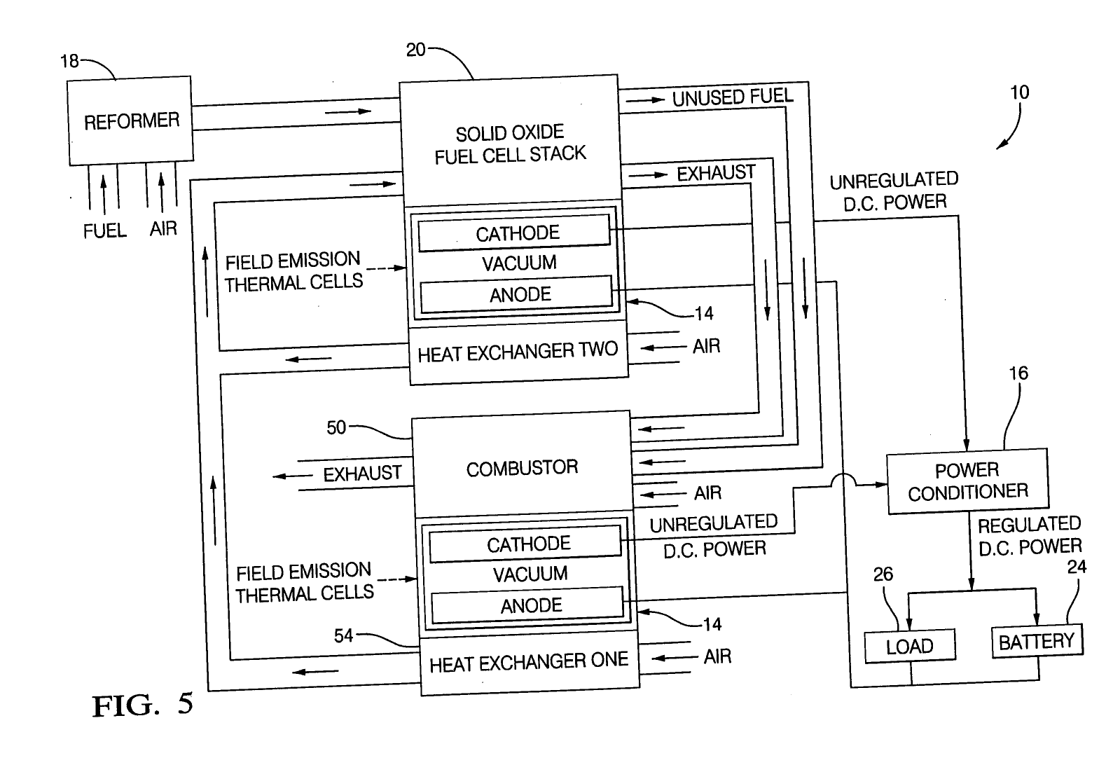

Referring now to FIG. 5 yet another exemplary embodiment is illustrated wherein features of the FIG. 3 embodiment is combined with a thermionic device in thermally conductive contact with the SOFC stack. In this embodiment, another thermionic device is directly coupled to the fuel cell stack in order to receive heat from the fuel cell stack in order to operate the thermionic device.

Although the various embodiments disclosed herein discuss and illustrate certain numbers of fuel cell stacks and thermionic devices it is, of course, contemplated that multiple devices (e.g., fuel cells, thermionic devices, combustors, etc.) may be employed in the various embodiments of the present invention.

In any of the embodiments discussed herein a controller or control module 60 is provided to operate the various components of the systems of exemplary embodiments of the present invention. The controller comprises among other elements a microprocessor for receiving signals 62 indicative of the system performance as well as providing signals 64 for control of various system components. The controller will also comprise read only memory and programmable memory in the form of an electronic storage medium for executable programs or algorithms and calibration values or constants, random access memory and data buses for allowing the necessary communications (e.g., input, output and within the controller) with the controller in accordance with known technologies.

The controller receives various signals from various sensors in order to determine various operating schemes of the disclosed system for example, whether the fuel cell system is warmed up and operating at a predetermined state wherein the desired heat exhaust is obtainable for the thermionic device. In addition, the controller will also operate the combustors in response to the operational status and needs of the system. Furthermore, the controller is capable of controlling the air intake into any of the devices discussed herein and is also capable of operating the cooling system of the FIG. 4 embodiment.

In accordance with operating programs, algorithms, look up tables and constants resident upon the microcomputer of the controller various output signals are provided by the controller. These signals can be used to vary the operation of the fuel cell stack, the thermionic device and alternatively the start up combustor.

Referring now to FIG. 7 an example of the combined efficiency of a power supply, comprising: a solid oxide fuel cell system and a thermionic device is provided wherein various SOFC efficiencies are used to illustrate the combined efficiency of the system. The examples of FIG. 7 are based upon a 65% utilization of the waste heat of the SOFC with a thermoelectric conversion efficiency of 20% by the thermionic device. In addition, FIG. 7 also illustrates the required thermoelectric active area (cm²) based upon an efficiency of 10.0 watts/cm².

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A power supply, comprising:
a solid oxide fuel cell system for providing a first source of power, said solid oxide fuel cell system also producing heat waste;
a thermionic device for providing a second source of power, said thermionic device providing said second source of power from said heat waste which is provided to said thermionic device; and
wherein said heat waste is in fluid communication with a heat exchanger of said thermionic device.

2. The power supply as in claim 1, further comprising:
an exhaust conduit providing fluid communication between an exhaust of said fuel cell system and a heat exchanger of said thermionic device.

3. The power supply as in claim 1, wherein said heat waste is generated by said solid oxide fuel cell system before, during, and after said solid oxide fuel cell is providing said first source of power.

4. The power supply as in claim 1, wherein said heat exchanger is configured to provide heat to a cathode of said thermionic device.

5. The power supply as in claim 4, wherein said cathode is located in a housing of said thermionic device and said cathode is separated from an anode of said thermionic device, wherein said heat causes electrons to separate from said cathode.

6. The power supply as in claim 5, wherein a vacuum is disposed between said anode and said cathode.

7. The power supply as in claim 4, wherein said thermionic device is configured to provide power when a heat source of approximately 700 degrees Celsius is provided to said cathode.

8. The power supply as in claim 7, wherein said power supply is configured for use in a vehicle.

9. The power supply as in claim 7, further comprising a power conditioner for receiving and conditioning power generated by said fuel cell system and said thermionic device.

10. The power supply as in claim 1, wherein said fuel cell system comprises a plurality of fuel cell stacks providing heat waste to a plurality of thermionic devices.

11. The power supply as in claim 1, further comprising another heat exchanger, said another heat exchanger providing an inlet and an exhaust of air to an anode of said thermionic device, wherein unheated air is supplied to said inlet and air heated by said anode is supplied to said exhaust, said anode being maintained at a temperature differential between a cathode of said thermionic device, said another heat exchanger also provides an exhaust to an inlet conduit of said fuel cell system.

12. The power supply as in claim 1, wherein said heat waste of said solid oxide fuel cell system is within a range defined by a lower limit of 400 degrees Celsius and an upper limit of 1,200 degrees Celsius when said solid oxide fuel cell system is providing said first source of power.

13. A power supply, comprising:
a solid oxide fuel cell system for providing a first source of power, said solid oxide fuel cell system producing heat waste when said solid oxide fuel cell is providing said first source of power;
a start up combustor for providing another source of heat;
an exhaust conduit providing fluid communication between an exhaust of said fuel cell system and an exhaust of said start up combustor to a first heat exchanger of a thermionic device, said thermionic device for providing a second source of power from heat received from either said start up combustor or said fuel cell system.

14. The power supply as in claim 13, wherein said heat waste of said solid oxide fuel cell system is within a range defined by a lower limit of 400 degrees Celsius and an upper limit of 1,200 degrees Celsius when said solid oxide fuel cell system is providing said first source of power.

15. The power supply as in claim 13, further comprising a second heat exchanger, said second heat exchanger providing an inlet and an exhaust of air to an anode of said thermionic device, wherein unheated air is supplied to said inlet and air heated by said anode is supplied to said exhaust, wherein said anode is maintained at a temperature differential between a cathode of said thermionic device.

16. The power supply as in claim 13, wherein said thermionic device and said start up combustor provide an initial source of power during a warm up phase of said fuel cell system.

17. The power supply as in claim 13, wherein said start up combustor is deactivated after said fuel cell system is providing power and said heat waste.

18. A method for generating power, comprising:
generating power from a thermionic device, said thermionic device generating power from heat received from a start up combustor under a first operating condition; and
generating power from a solid oxide fuel system, said solid oxide fuel system generating a heat exhaust when said solid oxide fuel system generates power, said heat exhaust being routed to said thermionic device, wherein said thermionic device generates power from heat exhaust when said heat exhaust reaches a predetermined temperature for energy conversion by said thermionic device.

19. The method as in claim 18, wherein said start up combustor is shut down when said heat exhaust reaches a predetermined temperature for energy conversion by said thermionic device.

20. The method as in claim 18, wherein said predetermined temperature is within the range defined by a lower limit of 400 degrees Celsius and an upper limit of 1,200 degrees Celsius.

21. The power supply as in claim 1, further comprising:
a means for providing fluid communication between an exhaust of said fuel cell system and a heat exchanger of said thermionic device.

22. A power supply, comprising:
a solid oxide fuel cell system for providing a first source of power, said solid oxide fuel cell system producing heat waste when said solid oxide fuel cell is providing said first source of power;
a combustor for providing another source of heat;
an exhaust conduit providing fluid communication between an exhaust of said fuel cell system and an inlet of said combustor wherein said combustor heats said exhaust of said fuel cell system to a temperature which causes a first thermionic device coupled to said combustor to provide a second source of power;
a first heat exchanger configured and positioned to cool or maintain the temperature of an anode of said first heat exchanger;
a second thermionic device configured and positioned to receive heated exhaust of said fuel cell stack, said second thermionic device providing another second source of power from heated exhaust received from said fuel cell system.

23. The power supply as in claim 22, wherein said first heat exchanger is coupled to a cooling system for cooling the anode of said first thermionic device.

24. The power supply as in claim 22, wherein said first heat exchanger is configured to receive ambient air for cooling the anode of said first thermionic device.

25. The power supply as in claim 22, wherein a second heat exchanger is configured and positioned to cool or maintain the temperature of an anode of said second thermionic device.
